(19) United States
(12) Patent Application Publication
(10) Pub. No.: US 2025/0161864 A1
(43) Pub. Date: May 22, 2025

(54) SYSTEM AND METHOD FOR TREATING COAL-FIRED FLUE GAS

(71) Applicant: HUANENG CLEAN ENERGY RESEARCH INSTITUTE, Beijing (CN)

(72) Inventors: Dongfang GUO, Beijing (CN); Ling YIN, Beijing (CN); Huanjun WANG, Beijing (CN); Yuanxue ZHANG, Beijing (CN); Zhaofang ZHENG, Beijing (CN); Lianbo LIU, Beijing (CN)

(73) Assignee: HUANENG CLEAN ENERGY RESEARCH INSTITUTE, Beijing (CN)

(21) Appl. No.: 19/030,535

(22) Filed: Jan. 17, 2025

Related U.S. Application Data
(63) Continuation of application No. PCT/CN2023/073063, filed on Jan. 19, 2023.

(30) Foreign Application Priority Data
Aug. 19, 2022 (CN) 202210998783.1

(51) Int. Cl. B01D 53/14; B01D 53/04; B01D 53/50; B01D 53/75; B01D 53/86

(52) U.S. Cl. CPC B01D 53/1406; B01D 53/0423; B01D 53/0446; B01D 53/1431; B01D 53/1481; B01D 53/502; B01D 53/75; B01D 53/8631; B01D 2251/404; B01D 2251/602; B01D 2253/102; B01D 2256/20; B01D 2257/302; B01D 2257/404; B01D 2257/504; B01D 2258/0283; B01D 2259/40086

(57) ABSTRACT

The present disclosure provides a system and method for treating coal-fired flue gas. The system for treating the coal-fired flue gas includes: a carbon dioxide capture and recovery system and a decarbonized gas concentration system; the carbon dioxide capture and recovery system is connected with a coal-fired apparatus, and the carbon dioxide capture and recovery system performs a carbon dioxide recovery treatment on coal-fired flue gas generated by the coal-fired apparatus; and the decarbonized gas concentration system is connected with the carbon dioxide capture and recovery system and the coal-fired apparatus, performs a concentration treatment on the coal-fired flue gas generated after the recovery treatment and delivers gas containing concentrated carbon monoxide into the coal-fired apparatus. The present disclosure performs the concentration treatment on the coal-fired flue gas generated after the recovery treatment and then delivers the treated gas into the coal-fired apparatus.

### CROSS-REFERENCE TO RELATED APPLICATIONS

The application claims priority to Chinese patent application No. 202210998783.1, filed on Aug. 19, 2022, the entire contents of which are incorporated herein by reference.

### TECHNICAL FIELD

The present disclosure relates to an air pollution control technology, in particular to a system and method for treating coal-fired flue gas.

### BACKGROUND

With industrial development and human activities, an atmospheric concentration of carbon dioxide rises continuously, which leads to unfavorable climate changes in the future such as continuous rising of an average temperature, declining of a sea level and increasing of rainfall. For avoiding various disasters, China has paid special attention to research and development of a carbon capture, utilization and storage (CCUS) technology in recent years, and carried out CCUS landing projects step by step in fields of electric power, buildings, industrial production, transportation, agriculture, etc., and the project scale and the quantity of projects have been increasing yearly. Among various fields, an emission quantity of carbon dioxide in the electric power industry is huge and accounts for 45% of a total emission quantity of the whole country, and thus carbon capture recovery for flue gas emissions of a thermal power plant and a coal-fired power plant has become the key field of the CCUS technical research.

In addition to a large quantity of gas such as nitrogen oxides, sulfur dioxide and carbon dioxide in flue gas generated by combustion of a boiler in a power plant, the flue gas needs to go through a conventional treatment such as desulfurization, denitrification and dedusting treatments and then is discharged to the atmosphere, however, carbon monoxide gas, volatile organic gas, refractory organics and the like caused by incomplete combustion remain in the flue gas generated after the treatments, and may cause severe secondary pollution when being directly discharged to the atmosphere from a chimney.

### SUMMARY

For overcoming at least one of drawbacks in the prior art, an embodiment of the present disclosure provides a system for treating coal-fired flue gas, including: a carbon dioxide capture and recovery system and a decarbonized gas concentration system;
the carbon dioxide capture and recovery system is connected with a coal-fired apparatus, and the carbon dioxide capture and recovery system performs a carbon dioxide recovery treatment on coal-fired flue gas generated by the coal-fired apparatus; and
the decarbonized gas concentration system is connected with the carbon dioxide capture and recovery system and the coal-fired apparatus, performs a concentration treatment on the coal-fired flue gas generated after the recovery treatment and delivers gas containing concentrated carbon monoxide into the coal-fired apparatus.

In the embodiment of the present disclosure, the decarbonized gas concentration system includes: an activated carbon adsorption apparatus, an air compressor, a preconcentration fan and a post-concentration fan;
the air compressor, the preconcentration fan and the post-concentration fan are all connected to the activated carbon adsorption apparatus; and
the coal-fired flue gas generated after the carbon dioxide recovery treatment enters the activated carbon adsorption apparatus through the preconcentration fan, the activated carbon adsorption apparatus performs an adsorption and removal treatment on the coal-fired flue gas, the air compressor performs a desorption treatment on activated carbon of the activated carbon adsorption apparatus, and the gas generated after the desorption treatment is delivered into the coal-fired apparatus through the post-concentration fan.

In the embodiment of the present disclosure, the activated carbon adsorption apparatus is an activated carbon concentrating tower.

In the embodiment of the present disclosure, the decarbonized gas concentration system further includes: an exhaust fan; and the exhaust fan is connected with the activated carbon adsorption apparatus.

In the embodiment of the present disclosure, the carbon dioxide capture and recovery system includes: an SCR denitrification reactor, a dust remover, a desulfurization apparatus, a pre-treatment apparatus and a carbon dioxide absorption apparatus;
the coal-fired apparatus is connected with the SCR denitrification reactor, the SCR denitrification reactor is connected to the desulfurization apparatus through the dust remover, and the desulfurization apparatus is connected to the carbon dioxide absorption apparatus through the pre-treatment apparatus; and
the coal-fired flue gas generated by the coal-fired apparatus is discharged and then enters the SCR denitrification reactor for a denitrification treatment, the flue gas generated after denitrification enters the dust remover so as to remove particles in the coal-fired flue gas, the desulfurization apparatus performs a desulfurization treatment on the coal-fired flue gas, and the flue gas generated after the desulfurization treatment enters the pre-treatment apparatus for cooling and removing moisture and then enters the carbon dioxide absorption apparatus for performing carbon dioxide capture.

In the embodiment of the present disclosure, the desulfurization apparatus includes: a wet-type desulfurization apparatus, a desulfurization water tank and a concentration basin; and
the concentration basin and the desulfurization water tank are both connected with the wet-type desulfurization apparatus, and the concentration basin is connected with the desulfurization water tank.

In the embodiment of the present disclosure, the dust remover is a bag dust remover.

In the embodiment of the present disclosure, the desulfurization apparatus is a wet-type desulfurization tower.

In the embodiment of the present disclosure, the carbon dioxide absorption apparatus is a carbon dioxide absorption tower.

Meanwhile, the present disclosure further provides a method for treating coal-fired flue gas, which treats the flue gas by using the aforementioned system for treating the coal-fired flue gas.

According to the system and method for treating the coal-fired flue gas provided by the present disclosure, the decarbonized gas concentration system is connected with the carbon dioxide capture and recovery system and the coal-fired apparatus, the concentration treatment is performed on the coal-fired flue gas generated after the recovery treatment, the gas containing the concentrated carbon monoxide is delivered into the coal-fired apparatus, decarbonized gas discharged after the carbon dioxide capture treatment is utilized efficiently, the decarbonized gas is desorbed as a small volume of gas having a high concentration and containing CO and volatile organic compounds, the gas is fed into the combustion apparatus as a supplemented gas source, and the concentrated gas CO and volatile organic compounds are high in content and in heat value and may serve as a gas fuel for reducing additional fuels and a heat value of the combustion apparatus, so as to improve combustion heat of the combustion apparatus. By using the method of decarbonized air concentration and then combustion, a temperature of a combustion furnace may be utilized effectively for decomposing volatile organic gas, refractory organics and the like which remain in the decarbonized gas and are caused by incomplete combustion, and organic amine may be prevented from escaping into the atmosphere through a reincineration manner so as to avoid the secondary pollution. Besides, according to the system and method for treating the coal-fired flue gas in the present disclosure, the carbon dioxide may be regenerated under the action of a high temperature after the concentrated CO gas enters the combustion furnace, the newly generated carbon dioxide may enter the subsequent carbon dioxide absorption tower along with the flue gas to be captured, and the carbon emission reduction efficiency is achieved to the maximum degree.

In order to make the above and other objectives, features and advantages of the present disclosure clearer and easier to understand, preferred embodiments are listed below and described in detail below with reference to the appended accompanying drawings.

### BRIEF DESCRIPTION OF DRAWINGS

In order to more clearly describe technical solutions in embodiments of the present disclosure or in the prior art, the accompanying drawings needed by the description in the embodiments or in the prior art will be briefly introduced below. Apparently, the accompanying drawings in the following description are only some embodiments of the present disclosure. Those ordinarily skilled in the art may also obtain other accompanying drawings according to these accompanying drawings without making creative work.

FIG. 1 is a schematic diagram of a system for treating coal-fired flue gas provided by the present disclosure.

FIG. 2 is a block diagram in an embodiment of the present disclosure.

FIG. 3 is a schematic diagram of an embodiment of the present disclosure.

### DETAILED DESCRIPTION OF THE EMBODIMENTS

The technical solutions in embodiments of the present disclosure are clearly and completely described in the following with reference to the accompanying drawings in the embodiments of the present disclosure. Apparently, the described embodiments are merely some rather than all of the embodiments of the present disclosure. All other embodiments obtained by those ordinarily skilled in the art based on the embodiments in the present disclosure without making creative efforts fall within the protection scope of the present disclosure.

In the prior art, for the treatment of coal-fired flue gas, after a carbon dioxide capture and recovery system is added, carbon monoxide gas, volatile organic gas, refractory organics and the like caused by incomplete combustion remain in decarbonized gas discharged out of a carbon dioxide absorption tower and may cause a severe secondary pollution when being directly discharged into the atmosphere from a chimney. In view of this, the present disclosure provides a system for carbon capture and then decarbonized tail gas purifying and synergistically improving coal-fired combustion heat, a large volume of gas having a low concentration and containing CO, volatile organic compounds (VOCs) and organic amine is desorbed as a small volume of gas having a high concentration by using a decarbonized gas concentration system, the small volume of gas is delivered back into a coal-fired combustion apparatus through a pipeline to supplement air in the combustion apparatus and meanwhile improve the combustion heat of the combustion apparatus by using the concentrated CO, VOCs and organic amine in the gas, in the meantime, a gas pollutant remaining in the flue gas may be decomposed under the action of a high temperature of the combustion apparatus so as to achieve the purpose of purification, carbon dioxide generated by CO gas combustion enters the subsequent carbon dioxide capture and recovery system along with the flue gas to be captured, and a carbon dioxide capturing rate is improved.

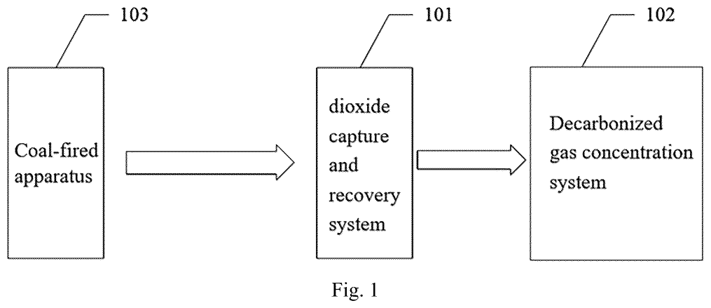

As shown in FIG. 1 which is a schematic diagram of a system for treating coal-fired flue gas provided by the present disclosure, the system includes: a carbon dioxide capture and recovery system 101 and a decarbonized gas concentration system 102.

The carbon dioxide capture and recovery system is connected with a coal-fired apparatus 103, and the carbon dioxide capture and recovery system 101 performs a carbon dioxide recovery treatment on coal-fired flue gas generated by the coal-fired apparatus 103.

The decarbonized gas concentration system 102 is connected with the carbon dioxide capture and recovery system 101 and the coal-fired apparatus 103, performs a concentration treatment on the coal-fired flue gas generated after the recovery treatment and delivers gas containing concentrated carbon monoxide into the coal-fired apparatus 103.

According to the system for treating the coal-fired flue gas provided by the present disclosure, the coal-fired flue gas generated after the recovery treatment is subjected to the concentration treatment by using the decarbonized gas concentration system, the gas containing the concentrated carbon monoxide is delivered into the coal-fired apparatus, a large volume of gas having a low concentration and containing CO, VOCs and organic amine is desorbed as a small volume of gas having a high concentration by using the decarbonized gas concentration system, the small volume of gas is delivered back into the coal-fired combustion apparatus through a pipeline to supplement air in the combustion apparatus and meanwhile improve combustion heat of the combustion apparatus by using the concentrated CO, VOCs and organic amine in the gas, a gas pollutant remaining in the fluc gas may be decomposed under the action of a high temperature of the combustion apparatus so as to achieve the purpose of purification, carbon dioxide generated by CO gas combustion enters the subsequent carbon dioxide capture and recovery system along with the flue gas to be captured, and a carbon dioxide capturing rate is improved.

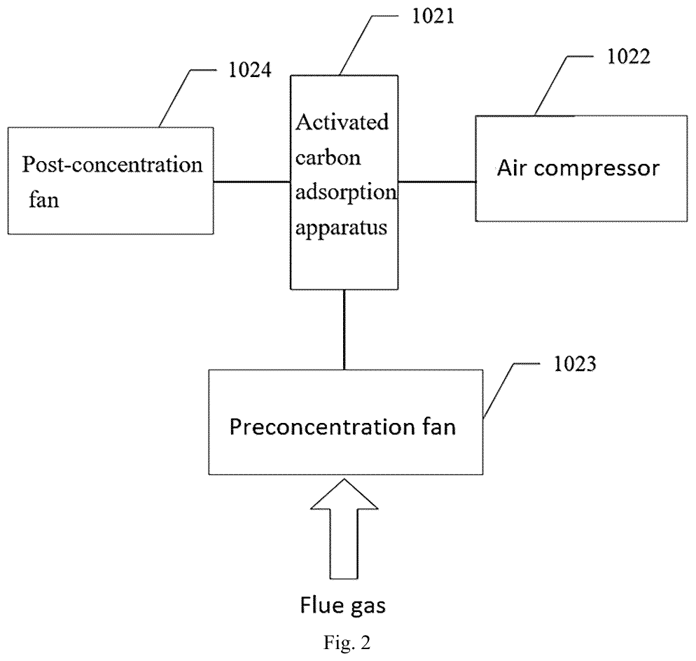

Further, in an embodiment of the present disclosure, as shown in FIG. 2, the decarbonized gas concentration system 102 includes: an activated carbon adsorption apparatus 1021, an air compressor 1022, a preconcentration fan 1023 and a post-concentration fan 1024.

The air compressor 1022, the preconcentration fan 1023 and the post-concentration fan 1024 are all connected to the activated carbon adsorption apparatus 1021. The coal-fired flue gas generated after the carbon dioxide recovery treatment enters the activated carbon adsorption apparatus through the preconcentration fan 1023, the activated carbon adsorption apparatus 1021 performs an adsorption and removal treatment on the coal-fired flue gas, the air compressor 1022 performs a desorption treatment on activated carbon of the activated carbon adsorption apparatus 1021, and the gas generated after the desorption treatment is delivered into the coal-fired apparatus through the post-concentration fan 1024.

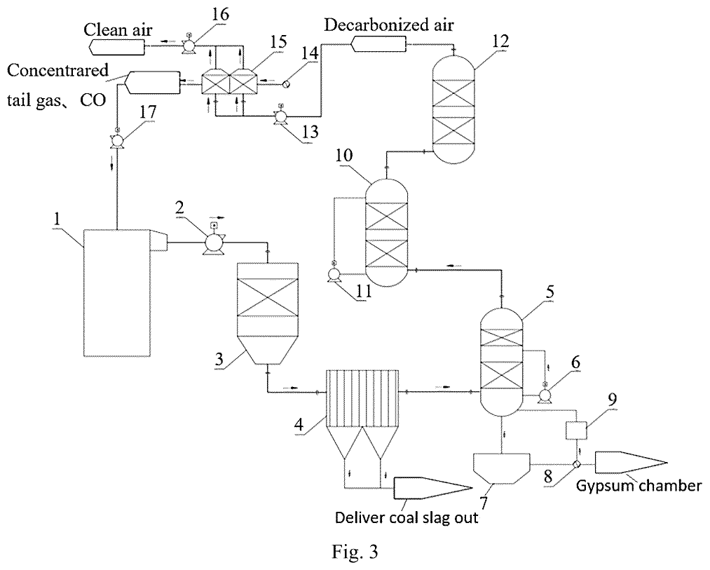

As shown in FIG. 3 which is a schematic diagram of a system for treating flue gas of a coal-fired power plant provided by an embodiment of the present disclosure, the flue gas of the power plant is discharged out of a combustion furnace 1 and then delivered into an SCR denitrification reactor 3 through an induced draft fan 2 for a denitrification treatment, the flue gas generated after the denitrification enters a bag dust remover 4 so as to remove particles in the gas and perform a two phase separation, solid-phase waste slag is discharged from below the dust remover 4 and then delivered out, then the coal-fired flue gas enters a wet-type desulfurization tower 5 for a desulfurization treatment, slurry generated by lime and sulfur dioxide is discharged from a tower bottom of the wet-type desulfurization tower 5 into a concentration basin 7, a solid-liquid separation is performed through a dewatering system 9, a solid phase is transported into a lime chamber, a liquid phase enters a circulating water tank to supplement water for the desulfurization tower, the gas generated after the desulfurization treatment enters a pre-treatment tower 10 for cooling and removing moisture, the gas is adjusted by the pre-treatment tower 10 and a pre-treatment pump 11 to be flue gas with an appropriate temperature and humidity and then enters a carbon dioxide absorption tower 12 to contact reversely with an absorption solution from bottom to top, carbon dioxide in the flue gas is captured into the solution, decarbonized tail gas enters an activated carbon concentrating tower 15 from a lower end under motivation of a preconcentration fan 13, carbon monoxide gas, volatile organic gas, refractory organics and the like generated by incomplete combustion and remaining in the gas may enter a special porous structure of activated carbon so as to be adsorbed and removed, decarbonized tail gas generated after the treatment is discharged through an exhaust fan 16, an activated carbon filler saturated through adsorption cuts off a gas inlet valve, an air compressor 14 is started to desorb the activated carbon, and CO-containing organic concentrated gas generated after desorption is fed back into the combustion furnace 1 under the action of a post-concentration fan 17.

Preferably, in an embodiment of the present disclosure, a temperature of the gas is adjusted to ≤50° C. through the pre-treatment tower 10 and the pre-treatment pump 11, mean relative humidity of the gas is adjusted to ≤60%, and thus an absorption effect is the best after entering the carbon dioxide absorption tower 12.

According to the system for treating the flue gas of the coal-fired power plant provided by the present embodiment, a system for carbon capture and then decarbonized tail gas purifying and synergistically improving combustion heat of a boiler of the coal-fired power plant is provided, high-temperature flue gas discharged out of the combustion furnace goes through SCR denitrification, the bag dust remover and wet desulfurization so as to remove nitrogen oxides, dust, sulfur dioxide and other impurities in the flue gas and then enters the carbon dioxide absorption tower to contact reversely with a carbon capture solvent containing organic amine, the carbon dioxide may react with the solvent so as to be captured, gas impurities such as CO, VOCs, organic amine volatilized from an absorbent and the like in the remaining flue gas that cannot be captured may be discharged directly with the decarbonized tail gas, and thus a secondary atmospheric pollution is caused. In the present disclosure, this part of decarbonized tail gas is subjected to adsorption and concentration via the activated carbon concentrating tower, the high-concentration gas generated after desorption and containing CO, VOCs and organic amine is fed into the combustion furnace through a pipeline, on the one hand, organic gas is removed under the action of high-temperature combustion, on the other hand, a concentration of the CO, VOCs, organic amine and the like in the gas is increased, a heat value of the gas may be reutilized when feeding into the combustion furnace, the combustion heat of the boiler is improved, and the purpose of saving energy is achieved.

By using the system for treating the flue gas of the coal-fired power plant provided by the present embodiment, carbon capture and then decarbonized tail gas purifying and synergistical improving of the combustion heat of the coal-fired boiler are implemented, the decarbonized gas discharged out of the carbon dioxide absorption tower is efficiently utilized, a large volume of organic gas having a lower concentration is desorbed as a small volume of gas having a high concentration and containing CO and volatile organic compounds under the action of the activated carbon concentrating tower, the gas is fed into the combustion furnace as a supplemented gas source, and the concentrated gas CO and the volatile organic compounds are high in content and in heat value and may serve as a gas fuel for reducing additional fuels and a heat value of the combustion furnace, so as to improve the combustion heat of the combustion furnace.

In addition, in the embodiment of the present disclosure, by using the method of decarbonized air concentration and then combustion, a temperature of the combustion furnace may be utilized effectively for decomposing the volatile organic gas, refractory organics and the like which remain in the decarbonized gas and are caused by incomplete combustion, and a part of organic amine may be volatilized by a circulation solvent in the carbon dioxide absorption tower and may be prevented from escaping into the atmosphere through a reincineration manner so as to avoid the secondary pollution.

In the embodiment of the present disclosure, the carbon dioxide may be regenerated under the action of a high temperature after the concentrated CO gas enters the combustion furnace, the newly generated carbon dioxide may enter the subsequent carbon dioxide absorption tower along with the flue gas to be captured, and the carbon emission reduction efficiency is achieved to the maximum degree. In the embodiment of the present disclosure, the activated carbon concentrating tower adopts a manner of partitioned adsorption and partitioned desorption, a gas flow direction is controlled through an air valve, and working efficiency is guaranteed.

Further, the present disclosure further provides a method for treating coal-fired flue gas, which treats the flue gas by using the aforementioned system for treating the coal-fired flue gas. Those skilled in the art may be clearly aware of an implementation of the method for treating the coal-fired flue gas provided by the present disclosure through the description of the above embodiment, which is not repeated here.

According to the system and method for treating the coal-fired flue gas provided by the present disclosure, the concentration treatment is performed on the coal-fired flue gas generated after the recovery treatment, the gas containing the concentrated carbon monoxide is delivered into the coal-fired apparatus, the decarbonized gas discharged after the carbon dioxide capture treatment is utilized efficiently, the decarbonized gas is desorbed as a small volume of gas having a high concentration and containing CO and volatile organic compounds, the gas is fed into the combustion apparatus as the supplemented gas source, and the concentrated gas CO and volatile organic compounds are high in content and in heat value and may serve as a gas fuel for reducing the additional fuels and the heat value of the combustion apparatus, so as to improve the combustion heat of the combustion apparatus. By using the method of decarbonized air concentration and then combustion, a temperature of the combustion furnace may be utilized effectively for decomposing the volatile organic gas, refractory organics and the like which remain in the decarbonized gas and are caused by incomplete combustion, and the organic amine may be prevented from escaping into the atmosphere through the reincineration manner so as to avoid the secondary pollution. Besides, according to the system and method for treating the coal-fired flue gas in the present disclosure, the carbon dioxide may be regenerated under the action of a high temperature after the concentrated CO gas enters the combustion furnace, the newly generated carbon dioxide may enter the subsequent carbon dioxide absorption tower along with the flue gas to be captured, and the carbon emission reduction efficiency is achieved to the maximum degree.

A principle and implementations of the present disclosure are set forth by using specific embodiments in the present disclosure, and the above description of the embodiments is only intended to help to understand the method of the present disclosure and its core concept. Meanwhile, those ordinarily skilled in the art may make variations in the specific implementations and the application scope according to the concept of the present disclosure, and to sum up, the content of the present specification is not supposed to be understood as a limitation on the present disclosure.

What is claimed is:

1. A system for treating coal-fired flue gas, comprising: a carbon dioxide capture and recovery system and a decarbonized gas concentration system;
wherein the carbon dioxide capture and recovery system is connected with a coal-fired apparatus, and the carbon dioxide capture and recovery system performs a carbon dioxide recovery treatment on coal-fired flue gas generated by the coal-fired apparatus; and
the decarbonized gas concentration system is connected with the carbon dioxide capture and recovery system and the coal-fired apparatus, performs a concentration treatment on the coal-fired flue gas generated after the recovery treatment and delivers gas containing concentrated carbon monoxide into the coal-fired apparatus.

2. The system for treating the coal-fired flue gas according to claim 1, wherein the decarbonized gas concentration system comprises: an activated carbon adsorption apparatus, an air compressor, a preconcentration fan and a post-concentration fan;
the air compressor, the preconcentration fan and the post-concentration fan are all connected to the activated carbon adsorption apparatus; and
the coal-fired flue gas generated after the carbon dioxide recovery treatment enters the activated carbon adsorption apparatus through the preconcentration fan, the activated carbon adsorption apparatus performs an adsorption and removal treatment on the coal-fired flue gas, the air compressor performs a desorption treatment on activated carbon of the activated carbon adsorption apparatus, and the gas generated after the desorption treatment is delivered into the coal-fired apparatus through the post-concentration fan.

3. The system for treating the coal-fired flue gas according to claim 2, wherein the activated carbon adsorption apparatus is an activated carbon concentrating tower.

4. The system for treating the coal-fired flue gas according to claim 2, wherein the decarbonized gas concentration system further comprises: an exhaust fan; and
the exhaust fan is connected with the activated carbon adsorption apparatus.

5. The system for treating the coal-fired flue gas according to claim 1, wherein the carbon dioxide capture and recovery system comprises: an SCR denitrification reactor, a dust remover, a desulfurization apparatus, a pre-treatment apparatus and a carbon dioxide absorption apparatus;
the coal-fired apparatus is connected with the SCR denitrification reactor, the SCR denitrification reactor is connected to the desulfurization apparatus through the dust remover, and the desulfurization apparatus is connected to the carbon dioxide absorption apparatus through the pre-treatment apparatus; and
the coal-fired flue gas generated by the coal-fired apparatus is discharged and then enters the SCR denitrification reactor for a denitrification treatment, the flue gas generated after denitrification enters the dust remover so as to remove particles in the coal-fired flue gas, the desulfurization apparatus performs a desulfurization treatment on the coal-fired flue gas, and the flue gas generated after the desulfurization treatment enters the pre-treatment apparatus for cooling and removing moisture and then enters the carbon dioxide absorption apparatus for performing carbon dioxide capture.

6. The system for treating the coal-fired flue gas according to claim 5, wherein the desulfurization apparatus comprises: a wet-type desulfurization apparatus, a desulfurization water tank and a concentration basin; and
the concentration basin and the desulfurization water tank are both connected with the wet-type desulfurization apparatus, and the concentration basin is connected with the desulfurization water tank.

7. The system for treating the coal-fired flue gas according to claim 5, wherein the dust remover is a bag dust remover.

8. The system for treating the coal-fired flue gas according to claim 5, wherein the desulfurization apparatus is a wet-type desulfurization tower.

9. The system for treating the coal-fired flue gas according to claim 5, wherein the carbon dioxide absorption apparatus is a carbon dioxide absorption tower.

10. A method for treating coal-fired flue gas, wherein the method treats the flue gas by using the system for treating the coal-fired flue gas according to claim 1.
